(19) United States
(12) Patent Application Publication
(10) Pub. No.: US 2010/0146132 A1
(43) Pub. Date: Jun. 10, 2010

(54) Methods, Systems, And Computer Program Products For Accessing A Resource Having A Network Address Associated With A Location On A Map

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/328,063

(22) Filed: Dec. 4, 2008

(51) Int. Cl. G06F 15/16

(52) U.S. Cl. 709/229

(57) ABSTRACT

Methods and systems are described for accessing a resource having a network address associated with a location on a map. In one aspect, a map representing a network address space and a geospatial region is provided on a client configured for accessing a network addressable space. A map location in the map corresponds to a geospatial location of the resource provider in the geospatial region and to a network address of the resource provider in the network address space. The client receives resource access information for accessing the resource from the resource provider. The client determines the geospatial location of the resource provider based on the resource access information. The client associates at least a portion of the resource access information with a map location corresponding to the geospatial location of the resource provider. Access to the resource is provided, via the map, based on the resource access information.

### RELATED APPLICATIONS

This application is related to the following commonly owned U.S. patent applications, the entire disclosure of each being incorporated by reference herein:

Application Ser. No. 11/962,285 (Attorney Docket No 1509/US) filed on Dec. 21, 2007, entitled “Methods And Systems For Sending Information To A Zone Included In An Internet Network”;

Application Ser. No. 12/170,281 (Attorney Docket No 1522/US) filed on Jul. 10, 2008, entitled “Methods And Systems For Resolving A Geospatial Query Region To A Network Identifier”;

Application Ser. No. 12/170,829 (Attorney Docket No 1523/US) filed on Jul. 10, 2008, entitled “Methods And Systems For Resolving Location Information To A Network Identifier”;

Application Ser. No. 12/170,833 (Attorney Docket No 1524/US) filed on Jul. 10, 2008, entitled “Methods And Systems For Resolving A Query Region To A Network Identifier”;

Application Ser. No. ______ (Attorney Docket No 1496/US) filed on ______, entitled “Methods, Systems, And Computer Program Products For Browsing Using A Geospatial Map Metaphor”

Application Ser. No. ______ (Attorney Docket No 1508/US) filed on ______, entitled “Methods, Systems, And Computer Program Products For Associating Resources Of A First Geospace With A Second Geospace”;

Application Ser. No. ______ (Attorney Docket No 1515/US) filed on ______, entitled “Methods, Systems, And Computer Program Products For Harmonizing A Geospatial Domain Space With A Non-Geospatial Domain Space”;

Application Ser. No. ______ (Attorney Docket No 1516/US) filed on ______, entitled “Methods, Systems, And Computer Program Products For Accessing A Resource Based On Metadata Associated With A Location On A Map”; and

Application Ser. No. ______ (Attorney Docket No 1527/US) filed on ______, entitled “Methods, Systems, And Computer Program Products For Determining A Network Identifier Of A Node Providing A Type Of Service For A Geospatial Region.”

### BACKGROUND

Internet users are accustomed to abstract information that is prevalent on the Internet. These users search for information and items based upon keywords. Most websites on the Internet have addresses registered in the .com domain. Companies located just about anywhere in the world can register a company's website in the .com domain. As a result, typical users have no sense of location when browsing the web. For example, a user searching for a resource based upon keywords may “click” through a series of hyperlinked information on different websites and end up at a website without having any sense of the underlying location of the resource within a navigation space. In order to access the resource, the user may need to know, with respect to the websites and the resource, where they are, where they have been, and/or where they are going. Without such knowledge, the user may not be able to access the resource.

### SUMMARY

Methods and systems are described for accessing a resource having a network address associated with a location on a map. In one aspect, a map representing a network address space and a geospatial region is provided on a client configured for accessing a network addressable space. A map location in the map corresponds to a geospatial location of the resource provider in the geospatial region and to a network address of the resource provider in the network address space. The client receives resource access information for accessing the resource from the resource provider. The client identifies the geospatial location of the resource provider based on the resource access information. The client associates the resource access information with the map location corresponding to the geospatial location of the resource provider. Access to the resource is provided, via the map location, based on the resource access information.

In another aspect, a navigation space handler component is configured to provide, on a client configured for accessing a network addressable resource provided by a resource provider, a map representing a network address space and a geospatial region. A map location in the map corresponds to a geospatial location of the resource provider in the geospatial region and to a network address of the resource provider in the network address space. A content manager component is configured to receive, by the client, resource access information for accessing the resource from the resource provider. A location resolver component is configured to determine, by the client, the geospatial location of the resource provider based on the resource access information. The navigation space handler component is configured to associate, by the client, at least a portion of the resource access information with the map location corresponding to the geospatial location. A map widget handler component is configured to provide for accessing the resource, via the map, based on the resource access information.

### BRIEF DESCRIPTION OF THE DRAWINGS

Advantages of the claimed subject matter will become apparent to those skilled in the art upon reading this description in conjunction with the accompanying drawings, in which like reference numerals have been used to designate like or analogous elements, and in which:

FIG. 1 is a flow diagram illustrating a method for accessing a resource having a network address associated with a location on a map according to an aspect of the subject matter described herein;

FIG. 2 is a block diagram illustrating a system for accessing a resource having a network address associated with a location on a map according to another aspect of the subject matter described herein;

FIG. 3 is a block diagram illustrating an exemplary execution environment in which the system of FIG. 2 may operate;

FIG. 4 is a block diagram illustrating hosting the exemplary execution environment in a node; and

FIG. 5 is an illustration of a browser interface used in accordance with the teachings herein.

### DETAILED DESCRIPTION

Prior to describing the subject matter in further detail, certain terms used in the description shall be defined to aid the reader.

A scope is a topological span within which a network address is usable. Scope is an indicator of a size, span, or boundary of a portion of a network referred to as a zone. For example, a link-local scope refers to an address span identifying network interfaces within a single link, such as an Ethernet LAN. A particular Ethernet LAN can be a zone. A global scope is an address span identifying network interfaces anywhere in the Internet. An interface-local scope is an address span specific to a network interface of a node. A site-local scope is an address span identifying interfaces anywhere within a site. An outside-scope is an address span identifying interfaces outside the scope of a zone. A scope can both span a first zone and not span a second zone in the first zone. For example, a site-outside-scope is an address span identifying interfaces anywhere inside a particular site and outside an identified zone in the site. Link outside-scope and interface outside-scope are defined analogously. Their scopes are relatively smaller than site outside-scope. The term outside-scope is used to refer to one or all of site outside, link outside, and interface outside-scopes unless otherwise noted. Other types of zones can be specified with an associated outside-scope. In general, a span outside of a zone with a given scope is referred to as a zone outside-scope.

A node is a device having a network interface such as an Ethernet network interface card (NIC) and/or a wireless adapter. A border node as described in U.S. application Ser. No. 11/962,285 is a node having an outside network interface for receiving, via a network path outside the scope of a zone, a packet addressed with an outside-scope unicast address including a portion identifying the zone. Outside-scope addresses are also described in U.S. application Ser. No. 11/962,285. A border node has an outside network interface having a network link to a network interface of node outside the zone. The border node can be configured to provide for processing a packet received via the outside network interface and sent from a node outside the identified zone. The border node has an inside network interface. The inside network interface of the border node can be included in the specified zone. The inside network interface is included in a network path including a network interface of a node in the identified zone.

A geospatial domain space includes one or more geospatial identifiers and corresponding regions. The domain space can be divided into domains. A domain is identified by an identifier from the domain space and, thus, has a geospatial region referred to herein as a domain region. A region or location of a geospatial domain space can be associated with a geospatial identifier that uniquely identifies the region/location in the context of the geospatial domain space. For example, the surface of the Earth, in whole and in part, has been and continues to be identified based on various types of 2-dimensional and 3-dimensional identifier spaces. Some domain spaces are associated with a grid system where each grid is identified by a tuple of coordinates, for example, a coordinate pair where one identifies a region in a horizontal orientation, and one identifies a region in a vertical orientation. The coordinate pair together identifies a region defined by intersection of the horizontal region and the vertical region. Several forms of GPS coordinate sets are currently in use including a Degrees/Minutes/Seconds domain space, a Degree Decimal Minutes domain space, and a Universal Transverse Mercator (UTM) domain space. A geospatial identifier associated with a geospatial domain space does not have to be coordinate-based. Any geospatial identifier that can identify regions/locations in the domain space is within the scope of the subject matter. For example, USA, NC, Cary, 111 Corning Rd, Suite 220 is a geospatial identifier identifying a business work site in the space that is occupied by the Earth for identifying a region on the surface of the Earth.

A geospatial identifier is any identifier that includes a portion that is usable for identifying a region/location of a geospatial domain space. Examples include:
postal://usa.nc.cary.corning-road:111.suite:220.placid
postal://placid.suite:220.corning_road:111.cary.nc.usa
postal://placid.suite:220:corning_road:111.27518
   Each of the above examples is from a geospatial domain space based on the US Post Office geospatial domain space that includes postal addresses.

The table below provides examples of three geospatial identifiers each from a different geospatial domain space specifying the same region, region A, on the Earth. The first geospatial identifier is from the World Geographic System (WGS) geospatial domain space. The second geospatial identifier is from the commonly known latitude/longitude geospatial domain space for addressing Earth regions. Each of the latitude and longitude coordinates can be expressed in degrees, minutes, and/or seconds. The third geospatial identifier is from the Global Positioning System (GPS) geospatial domain space.

| | WGS | | Deg/Min/Sec | | GPS | |
|---|---|---|---|---|---|---|
| Region | Latitude | Longitude | Latitude | Longitude | Latitude | Longitude |
| Region A | 30.29128 | −97.73858 | 30° 17′ 28″ | −97° 44′ 18″ | N30 17.477 | W97 44.315 |

Geospatial identifiers can be defined for specifying regions and locations having a variety of shapes including rectangles, circles, oval, or any shape including a closed region. A geospatial identifier can identify a region with disjoint sub-regions by including a geospatial attribute that identifies the sub-regions. For example, the identifier, “40+”, from an domain space including average annual rainfall totals over a specified period identifies a geospatial region including all sub-regions that have an average annual rainfall over 40 inches.

A geospatial identifier can include any of the forms and formats described above. Further a received geospatial identifier can be a network identifier if the form of geospatial network address or in the form of a geospatial name corresponding to at least a portion of a network address. A network identifier is an identifier for a communication endpoint on a network. An Internet Protocol (IP) address is a network identifier for communicating over an IP network such as the Internet. The domain name system (DNS) includes a set of names that include network identifiers. The DNS system is configured for mapping a DNS name to a network address. A network identifier can be at least one of a network address and a symbolic identifier of a network address, such as a DNS name.

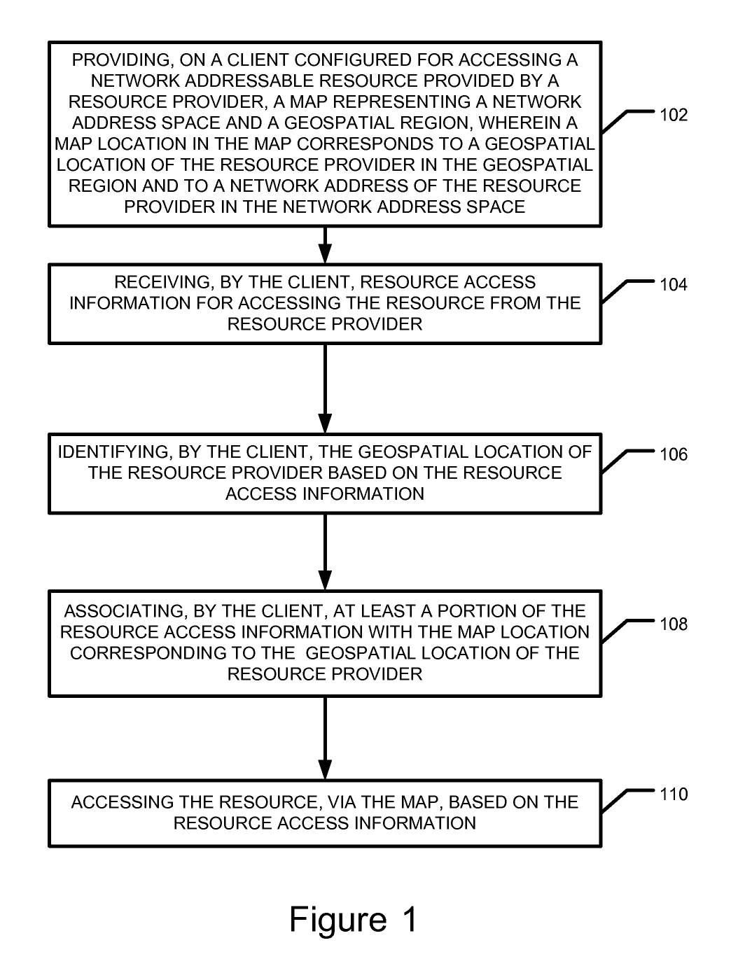

With reference to FIG. 1, in block 102 a map representing a network address space and a geospatial region is provided on a client configured for accessing a network addressable resource provided by a resource provider. The map represents a network address space and a geospatial region wherein a map location in the map corresponds to a geospatial location of the resource provider in the geospatial region and to a network address of the resource provider in the network address space. The map can be in the form of a road map, a satellite map, a topographic map, a geopolitical map, a weather map, a task map, a contents map, and the like. The map can be presented along with a representation of the network addressable resource. For example, the resource can be presented over, under, and/or to the side of the map.

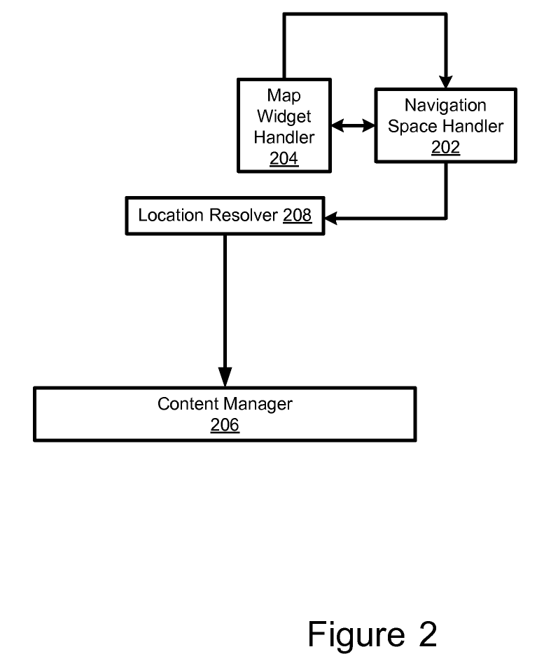

Accordingly, a system for accessing a resource having a network address associated with a location on a map includes means for providing, on a client configured for accessing a network addressable resource provided by a resource provider, a map representing a network address space and a geospatial region, wherein a map location in the map corresponds to a geospatial location of the resource provider in the geospatial region and to a network address of the resource provider in the network address space. For example, as illustrated in FIG. 2, a navigation space handler component 202 is configured to provide, on the client configured for accessing a network addressable resource provided by a resource provider, the map representing a network address space and a geospatial region, wherein a map location in the map corresponds to the geospatial location of the resource provider in the geospatial region and to the network address of the resource provider in the network address space.

The geospatial region includes a geospatial location of a resource provider identified on a network by a network identifier. The map, thus, represents a network domain space including the network identifier of the resource provider. The geospatial region corresponds to the network identifier. For example, the correspondence can be via the association of the geospatial location and the network identifier with the resource provider. See U.S. application Ser. Nos. 12/170,281, 12/170,829, and 12/170,833 for descriptions of methods and systems for determining a network identifier based on a geospatial location. Alternatively, a network identifier can be included in a geospatial domain space where each network identifier is a geospatial identifier identifying a location in a geospatial region associated with the domain space.

A network identifier can be a network address of a resource provider and/or a network name of the resource provider. The network address can be determined based on the network name. For example, a network name of a node operating in the Internet can be provided to a domain name server for identifying a network address of the node. The node can host a resource provider such as a file server and/or a web application. Whether a name or an address, a network identifier can be a geospatial identifier identifying a location in a geospatial region.

A network resource provider can be accessed via a network address of the resource provider. Resource access information for accessing a resource based on the above description can include geospatial information such as a geospatial network identifier of the resource provider, a geospatial identifier for determining a network identifier of the resource provider, a network name for determining a network address of the resource provider, and/or the network address of the resource provider. The URI domain space can include a network domain space such as an IP (Internet Protocol) address domain space, a DNS (Domain Name Server) name domain space and the like.

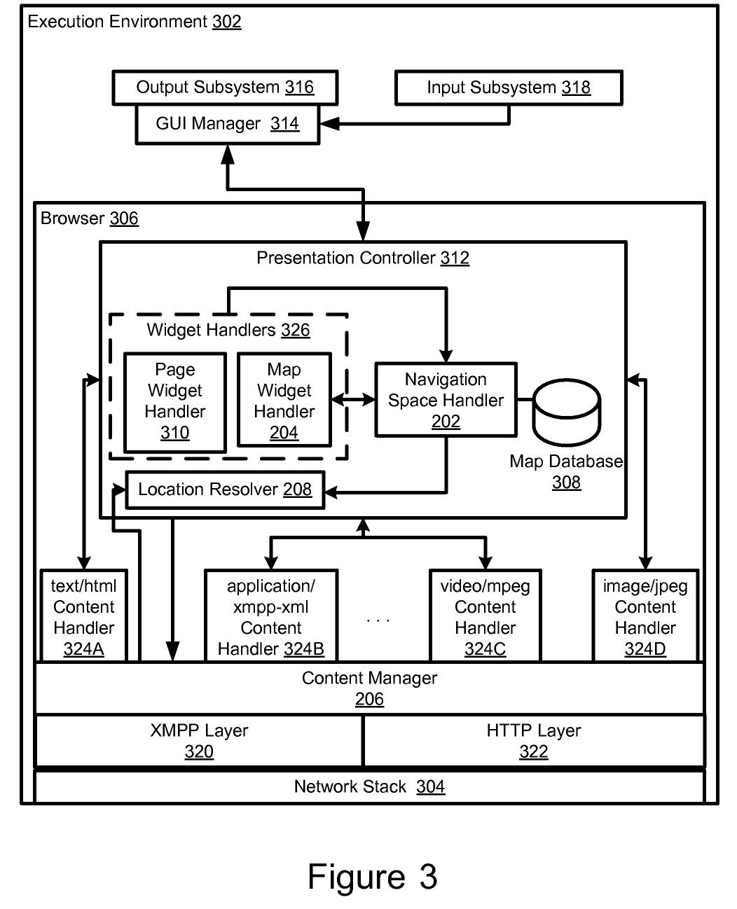

The components depicted in FIG. 2 can be adapted for performing the method depicted in FIG. 1 in a number of execution environments, such as the exemplary execution environment 302 illustrated in FIG. 3. Additionally or alternatively, an execution environment can be configured to host the components in FIG. 2 or analogous arrangements of components configured for performing the method depicted in FIG. 1.

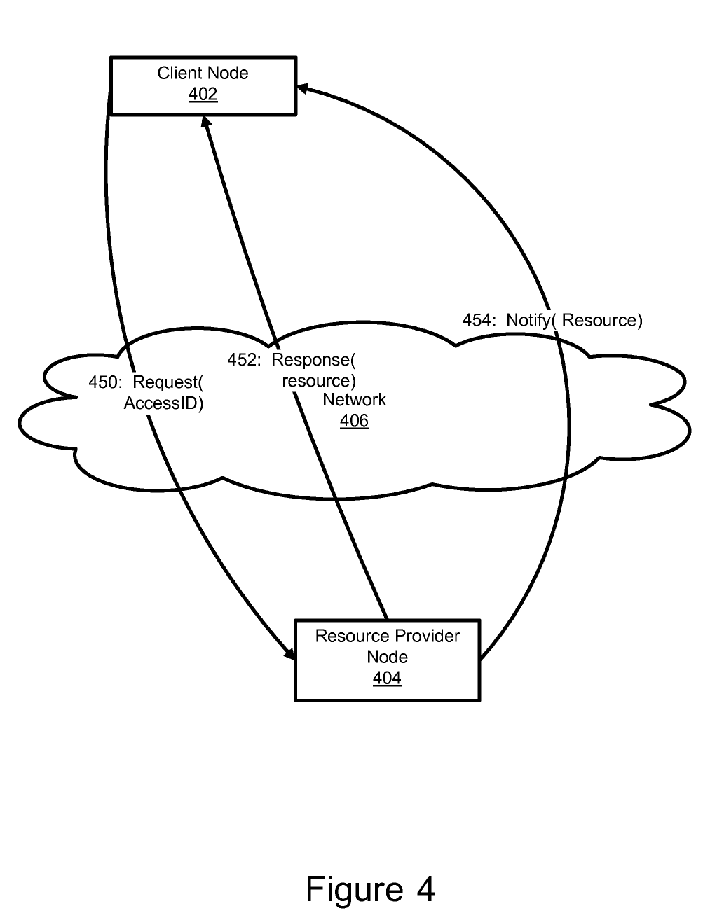

An execution environment such as the execution environment 302 can be hosted by a node or by multiple nodes as in a distributed execution environment. For example, in FIG. 4, a client node 402 can be configured to provide the execution environment 302 adapted to support the operation of the components in FIG. 2. An exemplary execution environment includes a memory for storing components and an instruction processing component, such as a processor, a digital signal processor (DSP) and the like, for processing instructions and any data associated with the operation of the components such as the components in FIG. 2.

The components in FIG. 2 and functionally analogous arrangements of components each can include additional hardware and/or software according to their particular operational configuration. For example, a network subsystem, such as the network stack 304 in FIG. 3, can be included in the execution environment 302 for communicating with a component in a remote device, such as a resource provider node 404 over a network 406 as described herein. An operating system, persistent data storage subsystem, memory management subsystem, and/or a process scheduler are other examples of components that can be used for various adaptations of the components in FIG. 2 and its functional analogs for performing the method depicted in FIG. 1.

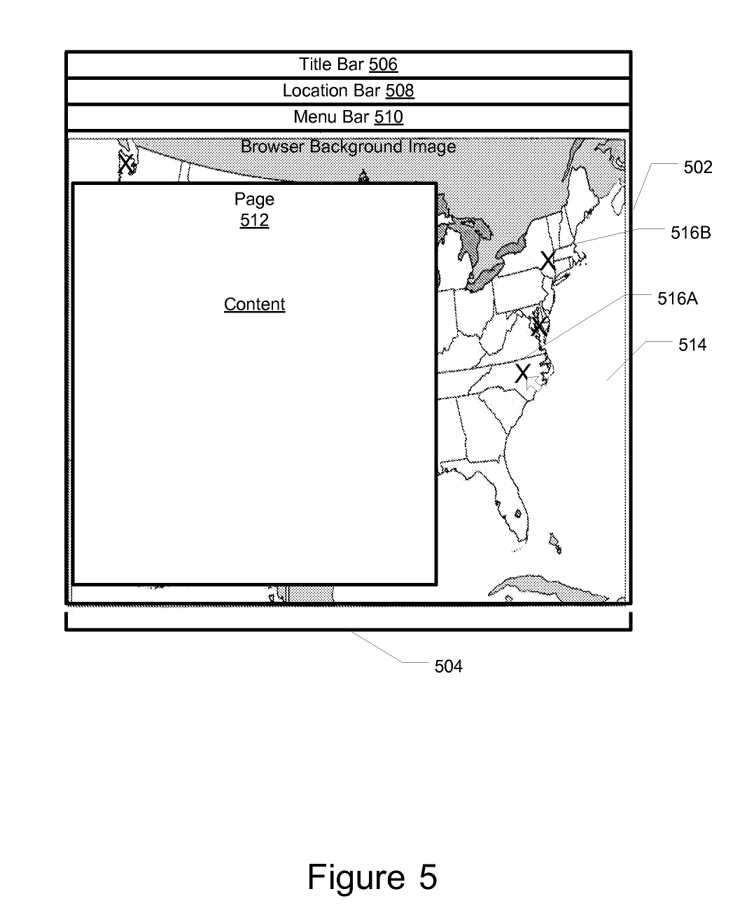

For example, as depicted in FIG. 3 a navigation space handler component 202 can be adapted to operate in a browser 306. The browser 306 can include and/or be operatively coupled to a map database 308. The navigation space handler component 202 can access map information stored in the map database 308 and provide a map based on the map information. The map information can be based on a task, a category of the resource provider, content of the resource, a location of the client (such as for example, a browser device), client configuration information, and the like. For example, maps can be shipped with and/or loaded into a browser configuration. Additional rules and/or policies can be established for determining when to present a particular map. Maps can also be selected for presentation with browsed resources by a user. The navigation space handler component 202 can provide the map to a map widget handler component 204 for presenting the map in a map widget 502 as illustrated in FIG. 5. FIG. 5 depicts an exemplary browser user interface including a browser widget 504 that provides a presentation space for presenting various user interface widgets of a browser. The browser widget 504, for example, includes a title bar widget 506, a location bar widget 508, and a menu bar widget 510. A page widget 512 can present content included in a network addressable resource provided by a resource provider.

As the map widget handler component 204 can be associated with the map widget 502, each of the widgets presented in a browser user interface can be associated with a corresponding widget handler component configured to present the widget and respond to user input received, if any, associated with the widget. For example, the page widget 512 is presented and managed by a page widget handler component 310.

The browser user interface can be managed by a presentation controller component 312 configured to coordinate and enable communication among the various widget handler components and enable communication with various components included in the execution environment 302 configured to present data via an output device such as a display (not shown) and/or an audio device; as well for receiving input associated with the presented data via one or more input devices (not shown).

The map can be identified in a URI scheme modifier. For a description of scheme modifiers and their use see U.S. application Ser. No. 11/615,438, filed on Dec. 22, 2006 and hereby incorporated in its entirety herein. For example, a URI scheme modifier included in example 1 below identifies the map.

### EXAMPLE 1

http;map=“http://%server%/maps/%path%://myserver.com/mypath/resource.

The exemplary URL illustrated in Example 1 includes a “map” scheme modifier keyword defined to identify a scheme value for accessing a map associated with a resource provider identified in a URL host portion, such as “myserver.com” in the example. The identified map can be specific to at least a portion of a path of a URL for a resource provider and/or at least a portion of a query portion of the URL allowing the map identified to vary based on the resource provider and the resource. In the example, the value http://%server%/maps/%path% is assigned to the keyword map as a map accessor. The value is specified as a template where variable portions are included in ‘%’ characters reserved to indicate variable portions. A reserved word “server” when used as a variable can be specified to indicate the variable is to be assigned the value of the host portion, “myserver.com” of the URL and a reserved word “path” when used in a variable is to be replaced by a path portion, “mypath/resource” of the URL.

Returning to FIG. 1, in block 104 the client receives resource access information for accessing the resource from the resource provider. Accordingly, a system for accessing a resource having a network address associated with a location on a map includes means for receiving, by the client, resource access information for accessing the resource from the resource provider. For example, as illustrated in FIG. 2, a content manager component 206 is configured for receiving, by the client, resource access information for accessing the resource from the resource provider.

The content manager component 206 can be configured to receive resource access information in the form of a URI via the browser user interface as described above with respect to the location bar widget 508. Other browser user interface widgets can be associated with input resource access information identifying a resource for accessing from a resource provider, also as described above. For example a mouse input can be received in association with a link presented in a web page in a page widget. The input resource access information can be provided to the page/tab widget handler parent-child widget hierarchy for processing. The presented link can be associated with a URI included in resource access information associated with the presented resource from a resource provider. The resource can have a type. The resource can be processed based on its type by a content handler, collectively referred to as the content handler components 324 and generically referred to as the content handler component 324.

FIG. 3 illustrates four exemplary content handler components 324 including a text/html content handler component 324A for processing a HTML formatted resource accessed via resource access information, an application/xmpp+xml content handler component 324B for processing an XMPP formatted resource, a video/mpeg content handler component 324C for processing a MPEG video resource, and an image/jpeg content handler component 324D for processing JPEG formatted image data.

The page widget handler component 310 can provide the display location associated with the mouse click, for example, to the content handler component 324 associated with the type of content presented at the display location. The content handler component 324 can determine that the location corresponds to a URI in the resource and can provide the URI as resource access information for receiving by the content manager component 206 for sending a message to a resource provider node identified based on the URI as described above for accessing the resource from the resource provider.

In an analogous manner the content manager component 206 can receive resource access information including a resource identifier based on user input such as, for example, a selection of a bookmark, an entry in a history list, the location bar, a page back and/or page forward user interface control, and via a number of number of inputs that can be configured to be associated with other user interface widgets and their corresponding widget handler components. The resource access information may be stored and retrieved from a client data store.

The content manager component 206 can receive resource access information in a request message sent to and/or a response message received from a resource provider. FIG. 4 illustrates a request message 450 sent from the client node 402 via the network 406 to the resource provider node 404. FIG. 4 also illustrates a response message 452 sent from the resource provider node 404 to the client node 402 via the network 406. The resource access information can also be received in a result set received in response to a query request. The client node 402 hosting the execution environment 302 can be configured to access a network addressable resource provided by a resource provider operating, for example, in a resource provider node 404. The browser 306 can receive resource access information, such as a uniform resource identifier (URI), of a network addressable resource via the browser user interface, for example, via the location bar 508. Alternatively, a portion of a resource identifier, such as a uniform resource locator (URL), can be determined based on the resource access information. For example, as described in U.S. application Ser. Nos. 12/170,281, 12/170,829, and 12/170,833, a network address can be determined based on location information. A network address of a resource provider having a location identified by resource access information can be determined based on the location information. Resource access information can be received via an entry in a bookmark and/or history list. The resource access information can be link information included in a resource received from a resource provider. The resource access information can include and/or identify metadata having a presentable representation that is presentable for selection for accessing a network addressable resource.

A GUI manager component 314 can be configured to interoperate with a display driver in an output subsystem 316 operatively coupled to a display for instructing the display via the display driver to present various widgets of the browser user interface including the location bar widget 508 as instructed by the various corresponding widget handler components included in the presentation controller component 312. The input can be received via a keyboard driver included in an input subsystem 318 and provided to the GUI manager component 314. The GUI manager component 314 can route input information based on a widget with focus such as the location bar widget 508. For example, the GUI manager component 314 can provide the input information directly to a location bar widget handler (not shown) or can provide the input information to another component of the browser associated with the location bar component 508. The presentation controller component 312, in an alternative, can be configured to mediate all communication between widget handler components and the GUI manager component 314. The input information can be received by the presentation controller component 312 for routing through zero or more child widget handler components and/or parent widget handlers of the location bar widget handler component to a widget handler in the child-parent hierarchy including the location bar widget handler component until the input information is processed.

The resource access information can be provided to the content manager 206 to generate a message for sending to a node identified via the URI. The message can be sent formatted according to a protocol identified by the URI. For example, the URI can be a URL with a scheme portion of the URL such as http:// or “xmp://” indicating that the message is to be sent formatted according to an HTTP protocol or an XMPP protocol, respectively. Based on the identified protocol, the content manager component 206 can provide the message content to a protocol layer, such as an XMPP layer 320 or an HTTP layer 322, for formatting according to a schema defining valid messages for the particular protocol layer. The protocol layer can send the message, such as the request message 450, to the identified node, such as the service provider node 404, via network stack 304 interoperatively coupled to the network 406 for routing the message to the identified node. The message can include resource access information such as a URL of the network addressable resource which can be received by the client node 402 in a message, such as the response message 452 and/or an asynchronous notify message 454, from a resource provider in the node, such as the resource provider node 404, identified based on the resource access information as described in more detail below.

As described above and illustrated in FIG. 4, the resource provider node 404 can send a message 452 in response to a request message 450 from the client node 402 including resource access information, such as a URI and or location information, for accessing a network addressable resource. The response message can include resource access information associated with the response for accessing at least a portion of the resource. Resource access information for accessing a resource can be included in the response header and/or in the message content including at least a portion of a resource, for example as a link in an HTML page. The response message can be received from the network 406 by the network stack 304 and provided to the browser 306, for example, based on a port number associated with the received response message 452 to an application protocol layer, such as the XMPP layer component 320 or the HTTP layer component 322 described above. The receiving application protocol layer can validate the message and provide the message payload and message information such as header information to the content manager component 206. The payload of the message and/or message information can include resource access information for accessing and one or more network addressable resources as just described.

The response message 452 may also include a portion of the resource. In one aspect, the resource and the resource access information can arrive in the same message. A link serving as resource access information in the resource can include a network identifier. The network identifier can be an outside-scope network identifier such as an outside-scope, unicast network address as described in U.S. application Ser. No. 11/615,438, filed on Dec. 12, 2006 and 11/957,809, filed on Dec. 17, 2007, both of which are hereby incorporated herein by their entirety.

Returning to FIG. 1, in block 106 the client identifies the geospatial location of the resource provider based on the resource access information. Accordingly, a system for accessing a resource having a network address associated with a location on a map includes means for identifying, by the client, the geospatial location of the resource provider based on the resource access information. For example, as illustrated in FIG. 2, a location resolver component 208 is configured for identifying, by the client, the geospatial location of the resource provider based on the resource access information.

The resource access information can include location information identifying a location of the resource provider. For example, a network identifier included in the resource access information can be a geospatial identifier. A portion of the geospatial identifier can identify a location of the resource provider. Alternatively, the resource access information can include a service type that can be used to determine a DNS service identifier. The service type or service identifier can be used to query a DNS service record to retrieve a service provider network address. The network address can be included in a query to a DNS server and/or other network directory service to retrieve a geospatial location of the resource provider. For example, many DNS servers maintain LOC records mapping IP network addresses to geospatial identifiers identifying respective geospatial locations. Alternatively, the resource access information can include a DNS network name of a node hosting the resource provider or a network address such as an IP address of the node the resource provider. The location resolver 208 can resolver an IP network address and/or a DNS network name to a location of the resource provider service node via a DNS query for a LOC (location) record associated with the IP network address and thus associated with a DNS network name associated with the IP network address in a DNS A record (address record) or PTR (pointer) record or their IPv6 analogs. Additional methods for determining the geospatial location of the resource provider by the client are described in co-pending U.S. applications Ser. Nos. 12/170,281, 12/170,829, 12/170,833, ______ (docket No. I508), ______ (docket No. I515), and ______ (docket No. I527).

Resource access information received via user input and/or a network message and received by the content manager component 206 can be provided by the content manager component 206 to the location resolver component 208 for determining the geospatial location of the resource provider.

In an example, resource access information can include and/or reference an outside-scope, unicast network address. A subnet represented by a border node can provide a location query service and/or the border node can be associated with a region and a resource provider of a resource accessible via the resource access information can have a node location at least partially present in the region of the subnet. The location of the resource provider can at the very least be narrowed to the region represented by the border node. A more precise location can be determined using any number of methods (e.g., the network interface identifier can be a geospatial identifier within the scope of the represented region, a lookup service can be provided for the region via the border node, a node in the region with a known location and a relationship to the service provider node can be used, etc.).

FIG. 3 depicts an adaptation of the components in FIG. 2 as operating among the components of FIG. 3 in the execution environment 302. In FIG. 3, a portion of the resource access information, such as a network address identifier can be provided by a widget handler component in the presentation controller component 312 to the navigation space handler component 202. For example, when a URI is received by a location bar widget handler component or by a link presented via a page/tab widget handler component 310, the receiving widget handler component can provide the received resource access information to the navigation space handler component 202 as illustrated by the arrow in FIG. 3 from a widget handlers component 326 to the navigation space handler component 202. When referenced in this document, the widget handler components 326 refers to the widget handler or widget handlers active in an operation being described.

Resource access information can be provided to the navigation space handler component 202 by a content handler component 324. When a message is received by the content manager component 206 (either incoming or outgoing) including resource access information, one or more resources or portions thereof in the received message can be provided to one or more content handler components 324 based on the type(s) of the one or more resources or resources portions. A content handler component 324 can be configured to provide the resource access information to the navigation space handler component 202. Based on the resource access information content as described above a network address of the resource provider can be determined. The resource access information can be provided directly and/or indirectly via the presentation controller component 312 and/or one or more widget handlers in the widgets handler components 326.

The navigation space handler component 202 can provide the resource access information to the location resolver component 208 for determining a geospatial location of the resource provider. Note that a resource provider can be associated with a geospatial location in a number of ways. For example the association between a geospatial location and a resource provider can be based on a relationship between a resource provider node and location of at least one of an owner of the node, a user of the node, an administrator of the node, a legal entity and the node, a purchase location and the node, a service location and the node, a subnet and the node, a naming domain and the node, an authentication service and the node, an authorization service and the node, a signer of a digital certificate and the node, a service provider and the node, etc. The node can be located in the geospatial location, represent the geospatial location, or be associated with the geospatial location in any conceivable manner.

Returning to FIG. 1, in block 108 the client associates at least a portion of the resource access information with the map location corresponding to the geospatial location of the resource provider. Accordingly, a system for accessing a resource having a network address associated with a location on a map includes means for associating, by the client, at least a portion of the resource access information with the map location corresponding to the geospatial location. For example, as illustrated in FIG. 2, a navigation space handler component 202 is configured for associating, by the client, at least a portion of the resource access identifier with the map location corresponding to the geospatial location.

The location resolver component 208 can return the determined geospatial location of the resource provider to the navigation space handler component 202. The navigation space handler component 202 can be configured to bind the geospatial location to a map location and/or can invoke a component included in the browser 306 and/or a plug-in associated with a map, such as a map 514 of the states of the United States as illustrated in FIG. 5. The map 514 can be presented by the map widget handler component 204 as described above. The associating/binding can be performed by various methods including methods based on a lookup table, based on a mapping function, based on a matching expression, and/or configuration data.

The associating of the resource access information with the map location can be performed before, during, and/or after the resource accessible via the resource access identifier is received, depending on the operation being performed by the browser 306 and/or depending on the configuration of the browser 306.

The map widget handler component 204 can be configured for presenting a representation of the at least a portion of resource access information for accessing the resource. The representation can be presented in a menu item, a list, a graphic in and/or over a map, and the like. For example the representation can be presented at a display location in a presentation of the map corresponding to the map location. FIG. depicts “X”s at a map location 516A associated with a resource provider having a map location 516A corresponding to a geospatial location of the resource provider in the state of North Carolina and at a map location 516B associated with a resource provider having a map location 516B corresponding to a geospatial location in the state of New York. Note that an input associated with a map location 516 can result in the presentation of any number of UI controls for accessing a resource accessed via the resource access information, editing metadata associated with the resource, or performing other resource/resource provider related actions. In response to associating metadata with a location on the map, a resource indicator associated with the resource access information can be presented at the location on the map in correspondence with presenting of the resource. The association of the metadata with the location on the map can be stored for presenting the indicator at a later time, allowing the resource access information to be accessed via an input received in correspondence with the presented resource access information indicator. When a browser is used, a previous resource and a next resource can be identified based on the stored metadata, thereby enabling forward and backward browsing. Additionally, an input can be defined that when received in correspondence with the map location indicates the resource can be accessed based on the resource access information.

Returning to FIG. 1, in block 110 the resource is accessed, via the map, based on the resource access information. Accordingly, a system for accessing a resource having a network address associated with a location on a map includes means for accessing the resource, via the map, based on the resource access information. For example, as illustrated in FIG. 2, a map widget handler component 204 is configured for accessing the resource, via the map, based on the resource access information.

An input corresponding to the map location 516A, for example, can be received by the input subsystem 318 and routed to the map widget handler component 204 as described above. The map widget handler component 204 can identify the resource access information based on the association between the map location 516A and the resource access information.

The map widget handler component 204 can identify the resource access information or alternatively can provide for identifying the resource access information, for example, by providing the map location to the navigation space handler component 202. The navigation space handler component 202 can locate the resource access information in the map database 308 where an association between the map location 516A and the resource access information for the resource provider having a location in North Carolina can be stored.

The association can be stored anytime after the map location is determined. Additional resource information can be stored as well. For example, the portion of the network address identifier used to determine the map location can be an IP address or node name as previously described. The remaining portion of the access identifier can be the remaining portion of a URL associated with a received and/or requested resource. The rest of the URL can be included in the resource access information stored in the association between the map location and resource access information in the map database 306.

When the resource access information is identified, the map widget handler component 204 can be configured to provide a network identifier of the resource provider such as the network address and optionally additional resource information to the content manager component 206 for generating a request for accessing the resource. The request can be sent via a request/response pair of messages such as an HTTP GET request and response. Alternatively, the resource can be accessed via a subscription by, for example, the content manager component 206 invoking the XMPP layer 320 to transmit a subscription message to a presence service or a publish-subscribe service. The resource can be received in one or more notification messages received from the subscription service via the network 406 and network stack 304 by the XMPP layer 320 for providing to the content manager component 206 for further processing as describe above.

It should be understood that the various system components (and means) defined by the claims and illustrated in the various block diagrams represent logical components that are configured to perform the functionality described herein. While at least one of these components are implemented at least partially as an electronic hardware component, and therefore constitutes a machine, the other components may be implemented in software, hardware, or a combination of the two. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of the two. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

Moreover, the methods described herein can be embodied in executable instructions stored in a computer readable medium for use by or in connection with an instruction execution machine, apparatus, or device, such as a computer-based or processor-containing machine, apparatus, or device. As used here, a “computer-readable medium” can include one or more of any suitable media for storing the executable instructions of a computer program in one or more of an electronic, magnetic, optical, and electromagnetic, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

The use of the terms “a” and “an” and “the” and similar referents in the context of describing the subject matter (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illuminate the subject matter and does not pose a limitation on the scope of the subject matter unless otherwise claimed. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for accessing a resource having a network address associated with a location on a map, the method comprising:
providing, on a client configured for accessing a network addressable resource provided by a resource provider, a map representing a network address space and a geospatial region, wherein a map location in the map corresponds to a geospatial location of the resource provider in the geospatial region and to a network address of the resource provider in the network address space;
receiving, by the client, resource access information for accessing the resource from the resource provider;
identifying, by the client, the geospatial location of the resource provider based on the resource access information;
associating, by the client, at least a portion of the resource access information with the map location corresponding to the geospatial location; and
accessing the resource, via the map, based on the resource access information,
wherein at least one of the preceding actions is performed on at least one electronic hardware component.

2. The method of claim 1 wherein the map is identified via a uniform resource identifier scheme modifier.

3. The method of claim 1 further comprising determining the map based on at least one of a task, a category of the resource provider, a content of the resource, and a location of the client.

4. The method of claim 1 wherein the map is one of a road map, a satellite map, a topographic map, a geopolitical map, a weather map, a task map, and a contents map.

5. The method of claim 1 wherein receiving the resource information comprises receiving the resource information in a message from a service provider including at least one of a portion of the resource and a reference for accessing the portion of the resource.

6. The method of claim 1 wherein the network address is an outside-scope, unicast address.

7. The method of claim 1 wherein the resource information is received via a user input.

8. The method of claim 1 further comprising determining at least one of a device name portion of a network name and a device address portion of a network address based on the resource access information.

9. The method of claim 1 further comprising determining a domain name system service identifier based on the resource access information.

10. The method of claim 1 wherein the resource information includes metadata associated with a presentable representation presentable for selection for accessing the network addressable resource.

11. The method of claim 10 wherein the presentable representation is presentable in at least one of a menu item, a list, and a map.

12. The method of claim 1 further comprising presenting a representation of the resource in a user interface widget in response to receiving the resource information.

13. The method of claim 12 further comprising in response to associating the resource information with the map location, presenting a resource indicator associated with the resource at the map location in correspondence with presenting the representation of the resource in the user interface widget.

14. The method of claim 1 further comprising identifying at least one of a previous resource and a next resource based on stored metadata associated with the map location.

15. The method of claim 1 wherein the map is determined based on client configuration information.

16. The method of claim 1 wherein receiving the resource information comprises receiving the resource access information in a result set received in response to a query request.

17. The method of claim 1 further comprising determining a portion of a uniform resource locator based on the resource access information.

18. A system for accessing a resource having a network address associated with a location on a map, the system comprising:
means for providing, on a client configured for accessing a network addressable resource provided by a resource provider, a map representing a network address space and a geospatial region, wherein a map location in the map corresponds to a geospatial location in the geospatial region and to a network address of the resource provider in the network address space;
means for receiving, by the client, resource access information for accessing the resource from the resource provider;
means for determining, by the client, the geospatial location of the resource provider based on the resource access information;
means for associating, by the client, at least a portion of the resource access information with the map location corresponding to the determined geospatial location of the resource provider; and
means for accessing the resource, via the map, based on the resource access information,
wherein at least one of the means includes at least one electronic hardware component.

19. A system for accessing a resource having a network address associated with a location on a map, the system comprising system components including:
a navigation space handler component configured to provide, on a client configured for accessing a network addressable resource provided by a resource provider, a map representing a network address space and a geospatial region, wherein a map location in the map corresponds to a geospatial location of the resource provider in the geospatial region and to a network address of the resource provider in the network address space;
a content manager component configured to receive, by the client, resource access information for accessing the resource from the resource provider;
a location resolver component configured to determine, by the client, the geospatial location of the resource provider based on the resource access information,
the navigation space handler component configured to associate, by the client, at least a portion of the resource access information with the map location corresponding to the geospatial location; and
a map widget handler component configured to provide for accessing the resource, via the map, based on the resource access information,
wherein at least one of the system components includes at least one electronic hardware component.

20. The system of claim 20 wherein the content manager component receives the resource access information in a message from a service provider including at least one of a portion of the resource and a reference for accessing the portion of the resource.

21. The system of claim 22 wherein the location resolver component determines at least one of a device name portion of a network name and a device identification portion of a network address based on the resource access information.

22. The method of claim 20 wherein the location resolver component determines a domain name system service identifier based on the resource access information.

23. The method of claim 20 wherein the map widget handler component presents a representation of the resource in a user interface widget in response to receiving the resource access information.

24. The method of claim 24 wherein the map widget handler component, in response to metadata in the resource access information being associated with the map location, presents a resource indicator associated with the resource at the map location in correspondence with presenting the representation of the resource in the user interface widget.

25. The method of claim 20 wherein the content manager component receives the resource access information in a result set received in response to a previous query result.

26. A computer readable medium storing a computer program, executable by a machine, for accessing a resource having a network address associated with a location on a map, the computer program comprising executable instructions for:
providing, on a client configured for accessing a network addressable resource provided by a resource provider, a map representing a network address space and a geospatial region, wherein a map location in the map corresponds to a geospatial location of the resource provider in the geospatial region and to a network address of the resource provider in the network address space;
receiving, by the client, resource access information for accessing the resource from the resource provider;
determining, by the client, the geospatial location of the resource provider based on the resource access information;
associating, by the client, at least a portion of the resource access information with the map location corresponding to the geospatial location; and
accessing the resource, via the map, based on the resource access information.
